(19) United States
(12) Patent Application Publication
(10) Pub. No.: US 2021/0295540 A1
(43) Pub. Date: Sep. 23, 2021

(54) DISPLACEMENT MEASUREMENT DEVICE, DISPLACEMENT MEASUREMENT SYSTEM, AND DISPLACEMENT MEASUREMENT METHOD

(71) Applicant: NEC Corporation, Tokyo (JP)

(72) Inventor: Yoshiaki SATO, Tokyo (JP)

(73) Assignee: NEC Corporation, Tokyo (JP)

(21) Appl. No.: 16/334,496

(22) PCT Filed: Sep. 15, 2017
(86) PCT No.: PCT/JP2017/033438

§ 371 Date: Mar. 19, 2019

(30) Foreign Application Priority Data
Sep. 21, 2016 (JP) 2016-184451

(51) Int. Cl. G06T 7/292; G06T 7/246; G06T 7/73; G01C 11/06

(52) U.S. Cl. CPC G06T 7/292; G06T 7/248; G06T 2207/30184; G01C 11/06; G06T 7/74

(57) ABSTRACT

A displacement of a measurement object is measured with high precision. A displacement measurement device 100 includes: an acquiring unit 110 for acquiring each of a first image including a first position and a second image including a second position, the images being captured in a first time period and a second time period, respectively; a correlating unit 120 for correlating the acquired first image and second image by using configuration information of an imaging means for capturing the first image and the second image; and a calculation unit 120 for calculating a displacement of the second position in the second time period from the first time period, the displacement being based on the first position, using the acquired first image and second image and the correlation by the correlating unit 120.

### TECHNICAL FIELD

The present disclosure relates to displacement measurement.

### Background Art

PTL 1 discloses a correction method at a time of displacement measurement by subtracting an error component due to a movement of a camera device. In addition, PTL 2 discloses a method of calculating a displacement or the like of a subject by simultaneously imaging the subject and a steady point other than the subject. Note that NPL 1 and NPL 2 disclose bundle adjustment for reconstructing a three-dimensional shape from images.

### CITATION LIST

### Patent Literature

[PTL 1] Japanese Unexamined Patent Application Publication No. 2007-240218 A
[PTL 2] Japanese Unexamined Patent Application Publication No. 2007-322407 A

### Non Patent Literature

[NPL 1] Hayato KOHAMA, and five others, “3D Reconstruction Method based on Bundle Adjustment using Affine-SIFT Algorithm”, Proceedings of Hinokunijouhou Symposium 2012, the Information Processing Society of Japan, March 2012
[NPL 2] Yuuki IWAMOTO, and two others, “Bundle Adjustment for 3-D Reconstruction: Implementation and Evaluation”, IPSJ SIG Technical Report, Vol. 2011-CVIM-175, No. 19, the Information Processing Society of Japan, January 2011

### SUMMARY OF INVENTION

### Technical Problem

Each of PTL 1 and PTL 2 discloses a method of suppressing an influence of a movement of a camera in displacement measurement using photographed images. However, in the methods described in PTL 1 and PTL 2, there is a problem that it is difficult to measure a displacement of a measurement object with high precision, unless the resolution of the camera is sufficiently high.

An illustrative object of the present disclosure is to provide technology for measuring a displacement of a measurement object with high precision.

### Solution to Problem

In one mode, there is provided a displacement measurement device including: an acquiring means for acquiring an image including a first position and an image including a second position, which are captured by an imaging means in a first time period, and an image including the first position and an image including the second position, which are captured by the imaging means in a second time period; and a calculation means for calculating a difference between the second position in the first time period and the second position in the second time period, the difference being based on the first position, using a plurality of the acquired images and correlation information calculated based on configuration information of the imaging means.

In another mode, there is provided a displacement measurement system including: an imaging means for capturing an image including a first position and an image including a second position in a first time period and in a second time period; and a calculation means for calculating a difference between the second position in the first time period and the second position in the second time period, the difference being based on the first position, using a plurality of the acquired images and correlation information calculated based on configuration information of the imaging means.

In still another mode, there is provided a displacement measurement method including: acquiring an image including a first position and an image including a second position, which are captured by an imaging means in a first time period, and an image including the first position and an image including the second position, which are captured by the imaging means in a second time period; and calculating a difference between the second position in the first time period and the second position in the second time period, the difference being based on the first position, using a plurality of the acquired images and correlation information calculated based on configuration information of the imaging means.

In still another mode, there is provided a program for causing a computer to execute: a process of acquiring an image including a first position and an image including a second position, which are captured by an imaging means in a first time period, and an image including the first position and an image including the second position, which are captured by the imaging means in a second time period; and a process of calculating a difference between the second position in the first time period and the second position in the second time period, the difference being based on the first position, using a plurality of the acquired images and correlation information calculated based on configuration information of the imaging means.

### Advantageous Effects of Invention

According to the present disclosure, a displacement of a measurement object is measured with high precision.

### BRIEF DESCRIPTION OF DRAWINGS

FIG. 1 is a block diagram illustrating an example of a configuration of a displacement measurement device;

FIG. 2A is a conceptual view for explaining a displacement which is calculated by a calculation unit;

FIG. 2B is another conceptual view for explaining a displacement which is calculated by the calculation unit;

FIG. 3 is a flowchart illustrating an example of a displacement measurement method which is executed by the displacement measurement device;

FIG. 4 is a block diagram illustrating an example of a configuration of a displacement measurement system;

FIG. 5 is a view illustrating a positional relationship between cameras;

FIG. 6 is a view illustrating a measurement object and imaging positions;

FIG. 7 is an explanatory view illustrating an example of an execution method of calibration for calculating a homogeneous transformation matrix;

FIG. 8 is a flowchart illustrating an example of a displacement measurement process which the displacement measurement device executes;

FIG. 9 is a block diagram illustrating another example of the configuration of the displacement measurement system;

FIG. 10A is a block diagram illustrating another example of the configuration of the displacement measurement device;

FIG. 10B is a block diagram illustrating still another example of the configuration of the displacement measurement device;

FIG. 10C is a block diagram illustrating still another example of the configuration of the displacement measurement device;

FIG. 11 is a block diagram illustrating still another example of the configuration of the displacement measurement system;

FIG. 12 is a block diagram illustrating still another example of the configuration of the displacement measurement system; and

FIG. 13 is a block diagram illustrating an example of a hardware configuration of a computer device.

### EXAMPLE EMBODIMENT

### First Example Embodiment

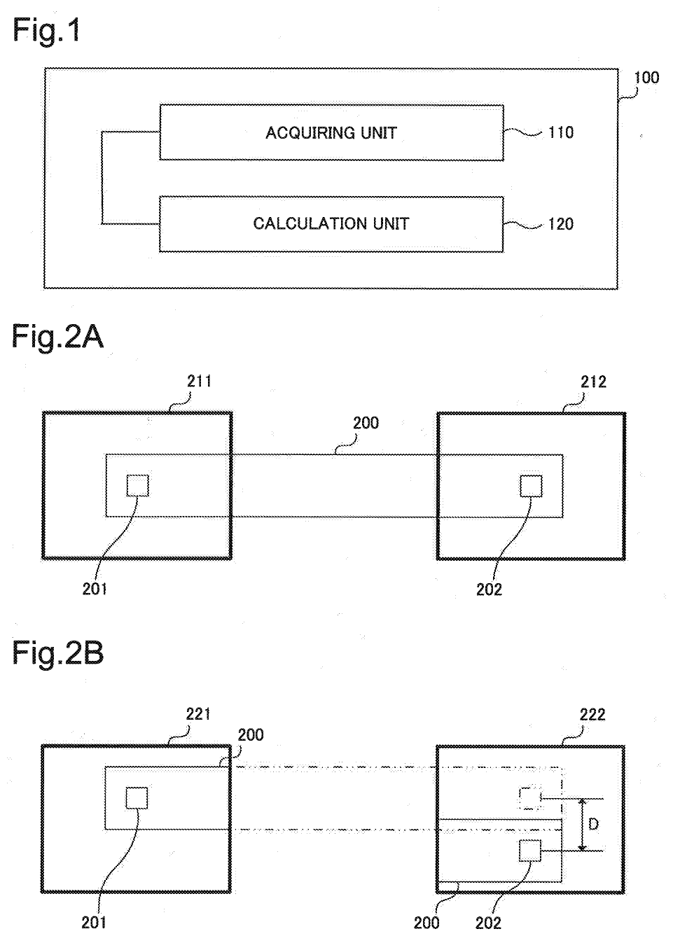

FIG. 1 is a block diagram illustrating a configuration of a displacement measurement device 100 according to one example embodiment. The displacement measurement device 100 is a device for measuring a displacement in a measurement object. The displacement measurement device 100 includes at least an acquiring unit 110 and a calculation unit 120.

The measurement object in this context is, for instance, a construction such as a building or a bridge. In some modes, the measurement object is an object which requires high-precision displacement measurement, compared to the size of the object. However, the measurement object is not limited to a specific object, if displacement measurement by methods to be described below is possible. In addition, although displacement of the measurement object occurs due to factors such as time (degradation or the like), temperature (thermal expansion or the like) and a load (presence/absence of a load, or the like), the factors are not limited to specific factors.

The acquiring unit 110 acquires images captured by an imaging unit. The imaging unit in this context is configured to include, for example, one or a plurality of cameras each including an imaging element for converting light to image information of each pixel, such as a Charge-coupled device (CCD) image sensor or a Complementary metal-oxide-semiconductor (CMOS) image sensor. The imaging unit may be mounted on a moving body such as a vehicle or aircraft.

The acquiring unit 110 acquires an image, for example, by accepting an input of image data which are expressed in a predetermined format. The image acquired by the acquiring unit 110 may be a visible image, but may also be an image including information of a wavelength in an invisible region of near-infrared light or the like. In addition, the image acquired by the acquiring unit 110 may be either a monochromatic image or a color image, and the number of pixels or the number of gray levels (color depth) are not particularly limited. The acquisition by the acquiring unit 110 may be acquisition via a communication line, or may be readout from a recording medium included in the own device or in some other device.

The acquiring unit 110 acquires an image including a first position, and an image including a second position. The first position is a position which serves as a base in displacement measurement. On the other hand, the second position is a different position from the first position, and is a position of an object of displacement measurement. For example, the first position is a position whose displacement does not substantially occur or is negligibly small, compared to the displacement of the second position. The second position is, for example, a position whose displacement tends to easily occur or can easily be measured. Hereinafter, the image including the first position is also referred to as “first image”, and the image including the second position is also referred to as “second image”.

The first position and second position may be any positions, if distinction from other positions is possible. The first position and second position may be positions which are provided with signs, such as markers, which make visual identification easier. Alternatively, for example, when it is difficult to dispose a sign on a measurement object, the first position and second position may be visually identified by a slight difference in roughness or color on the surface of the object.

The second position is a part of the measurement object. On the other hand, the first position may be, or may not be, a part of the measurement object. For example, the first position may be a part of another object whose displacement is smaller than the displacement of the measurement object (or whose displacement does not occur). Specifically, it is not always necessary that the first position and second position be included in a single object.

The acquiring unit 110 acquires a first image and a second image, which are captured in a first time period, and a first image and a second image, which are captured in a second time period. In other words, the acquiring unit 110 acquires a plurality of first images and a plurality of second images, which are captured at different timings. The second time period is, for example, after the first time period, and is a period in which a displacement occurs (or may possibly occur) in the measurement object. A plurality of first images and a plurality of second images may be captured in each of the first time period and second time period.

The first image and second image are, for example, a pair of images captured at a predetermined timing. The acquiring unit 110 can also acquire the first image and second image by acquiring a movie from the imaging unit and extracting still images at specific time points of the acquired movie. For example, the acquiring unit 110 may extract still images captured at an identical time instant from a plurality of movies captured by a plurality of cameras, and may use the extracted still images as the first image and second image. Alternatively, the acquiring unit 110 may use, as the first image and second image, still images captured by a plurality of cameras which are controlled to perform imaging at the same timing.

The calculation unit 120 calculates a displacement of the measurement object. The calculation unit 120 calculates a displacement of the second position, the displacement being based on the first position, by using the images acquired by the acquiring unit 110, and correlation information calculated based on configuration information of the imaging unit. The displacement in this context means a difference between the second positions when the second position in the first time period and the second position in the second time period are compared.

The configuration information in this context is, for example, information indicative of a difference between imaging directions of the first image and second image, and magnifications of imaging of the first image and second image. For example, when the first image and second image are captured by different cameras, the configuration information may represent the imaging conditions of the plural cameras. The imaging conditions in this context include, for example, relative positions or angles of the plural cameras. The configuration information may be stored in advance in the displacement measurement device 100, or may be acquired via the acquiring unit 110 together with the first image and second image.

The correlation information is described by, for example, a homogenous transformation matrix, Euler's angle, quaternion, etc. The correlation information makes it possible to describe the coordinates of the first image and the coordinates of the second image by using a common coordinate system. The correlation information may be calculated by the displacement measurement device 100, or may be calculated in advance by a device which is different from the displacement measurement device 100.

The correlation information correlates the first image and second image. To be more specific, the correlation information correlates the first image and second image which are captured in the same time period. It can also be said that the correlation by the correlation information is correlating the first position included in the first image and the second position included in the second image. By using the correlation information, the calculation unit 120 can correlate a plurality of images whose imaging ranges do not overlap.

FIG. 2A and FIG. 2B are conceptual views for explaining a displacement which is calculated by the calculation unit 120. In an example illustrated in FIG. 2A and FIG. 2B, it is assumed that a first position 201 and a second 202 of a measurement object 200 are separately photographed by two cameras. It is assumed that the cameras are fixed by a rigid body or the like, so that the positional relationship therebetween may not change. FIG. 2A illustrates imaging in a first time period. In addition, FIG. 2B illustrates imaging in a second time period.

A first camera captures a first image 211 in the first time period, and captures a first image 221 in the second time period. The first images 211 and 221 are common in that the first images 211 and 221 include the first position 201, but their imaging ranges may not necessarily agree. In addition, a second camera captures a second image 212 in the first time period, and captures a second image 222 in the second time period.

The relative positional relationship between the first camera and second camera is unchanged between the first time period and second time period. Then, assuming that the measurement object 200 has not deformed, the position where the measurement object 200 appears in the second image 222 in the second time period can uniquely be specified from the first image 221 in the second time period and the configuration information, as indicated by a two-dot-and-dash line in FIG. 2B.

However, assuming that the measurement object 200 has actually deformed, the position where the measurement object 200 appears in the second image 222 becomes a different position from the position indicated by the two-dot-and-dash line. The calculation unit 120 can calculate a displacement D, based on the difference between the actual position of the second position 202 in the second image 222 and a position which can be assumed from the first image 221 and the correlation information.

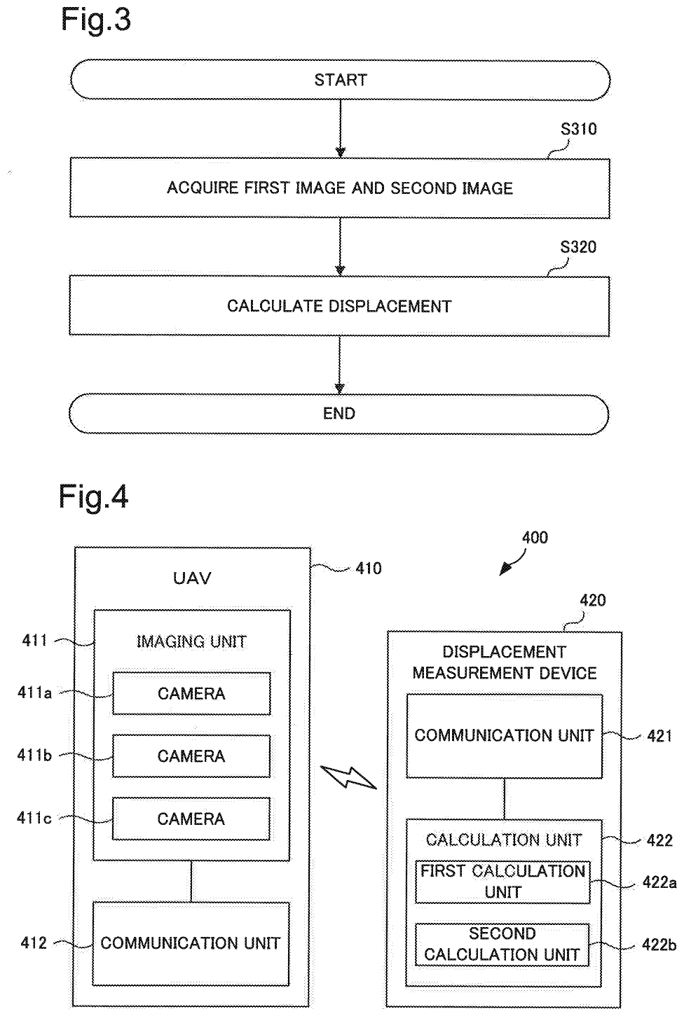

FIG. 3 is a flowchart illustrating an example of a displacement measurement method which is executed by the displacement measurement device 100. The displacement measurement device 100 executes a process in accordance with the example of FIG. 3.

In step S310, the acquiring unit 110 acquires a first image and a second image which are captured in the first time period, and a first image and a second image which are captured in the second time period. Note that the acquiring unit 110 may simultaneously acquire, or may acquire at different timings, the images captured in the first time period and the images captured in the second time period. In step S320, the calculation unit 120 calculates a displacement of the measurement object by using the first images and second images acquired in step S310 and the correlation information.

As described above, the displacement measurement device 100 is configured to calculate a displacement of the measurement object by using the correlation information which is calculated based on the configuration information of the imaging unit. This configuration enables displacement measurement by local imaging of the measurement object, without imaging the entirety of the measurement object. Thus, according to the displacement measurement device 100, compared to the case in which the entirety of the measurement object is imaged, the resolution per unit area of the image including the measurement object can be enhanced, and therefore the displacement of the measurement object can measured with high precision. In other words, it can be said that the displacement measurement device 100 can measure the displacement of the measurement object with high precision, even without enhancing the resolution of image sensors.

Second Example Embodiment

FIG. 4 is a block diagram illustrating a configuration of a displacement measurement system 400 according to another example embodiment. The displacement measurement system 400 includes an Unmanned Aerial Vehicle (UAV) 410, and a displacement measurement device 420. The UAV 410 and displacement measurement device 420 are configured to be capable of communicating data by radio.

The UAV 410, while flying, images a measurement object. The UAV 410 may be remote-controlled by the displacement measurement device 420 or other remote-control equipment, and may also be configured to image a specific position of the measurement object by image recognition. Further, the UAV 410 may be configured to continue imaging a specific position of the measurement object for a predetermined time period, while hovering. The UAV 410 includes an imaging unit 411 and a communication unit 412.

The imaging unit 411 further includes cameras 411a, 411b and 411c. The imaging unit 411 generates image data representing images captured by the cameras 411a, 411b and 411c, and supplies the generated image data to the communication unit 412. The imaging unit 411 may execute a well-known image process for facilitating an arithmetic process in the displacement measurement device 420. In addition, the imaging unit 411 may capture not a still image but a movie.

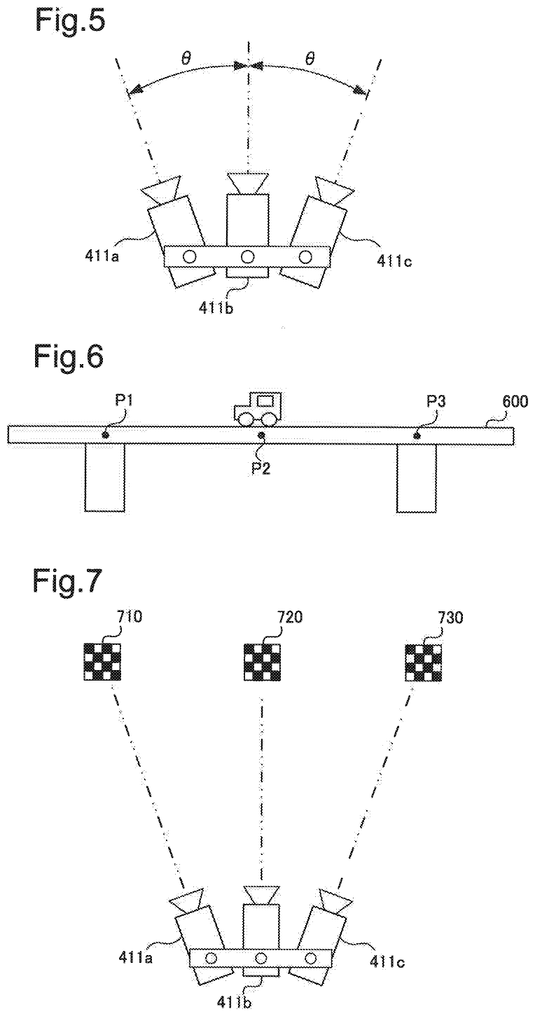

FIG. 5 is a view illustrating a positional relationship between the cameras 411a, 411b and 411c. The cameras 411a, 411b and 411c are fixed so as to maintain a specific positional relationship. For example, in the example illustrated in FIG. 5, the cameras 411a, 411b and 411c are mounted on the UAV 410 in a state in which their imaging directions vary in units of an angle θ. The cameras 411a, 411b and 411c are firmly fixed by a rigid body or the like, such that the positional relationship does not change by vibration due to the flying of the UAV 410.

The communication unit 412 transmits the image data, which are supplied from the imaging unit 411, to the displacement measurement device 420. The communication unit 412 executes a process, such as encoding, on the image data supplied from the imaging unit 411, and transmits the image data to the displacement measurement device 420 according to a predetermined communication method.

The displacement measurement device 420 includes a communication unit 421 and a calculation unit 422. The communication unit 421 receives image data from the UAV 410. The communication unit 421 supplies the image data, which were transmitted via the communication unit 412, to the calculation unit 422. The calculation unit 422 further includes a first calculation unit 422a which calculates a homogeneous transformation matrix, and a second calculation unit 422b which calculates a displacement of the measurement object. The homogeneous transformation matrix corresponds to an example of the correlation information in the first example embodiment. The second calculation unit 422b calculates a displacement of the measurement object by using the image data supplied from the communication unit 421 and the homogeneous transformation matrix calculated by the first calculation unit 422a.

In the present example embodiment, the communication unit 421 corresponds to an example of the acquiring unit 110 in the displacement measurement device 100 of the first example embodiment. In addition, the calculation unit 422 corresponds to an example of the calculation unit 120 in the displacement measurement device 100 of the first example embodiment.

Note that the displacement measurement device 420 may include a configuration for recording the displacement calculated by the calculation unit 422. For example, the displacement measurement device 420 may include a recording device which records in a recording medium the displacement calculated by the calculation unit 422 together with the date/time (imaging date/time). Alternatively, the displacement measurement device 420 may include a display device which displays information corresponding to the displacement calculated by the calculation unit 422.

The displacement measurement system 400, under the above configuration, images the measurement object and calculates the displacement of the measurement object. Specifically, the displacement measurement system 400 can calculate the displacement of the measurement object by operating as described below. Hereinafter, as an example, it is assumed that the measurement object is a bridge.

FIG. 6 is a view illustrating a measurement object and imaging positions. In this example, the displacement measurement system 400 measures a displacement of a bridge 600, in particular, bending of a floor system, due to the running of a vehicle. In the bridge 600, positions that are imaged by the UAV 410 are P1, P2 and P3. The positions P1 and P3 are positions, such as vicinities of bridge piers, where it can be assumed that there occurs no displacement due to the running of the vehicle. The positions P1 and P3 are photographed by the cameras 411a and 411c. On the other hand, the position P2 is a position, such as an intermediate point between the bridge piers, where a displacement due to the running of the vehicle is relatively large. The position P2 is photographed by the camera 411b.

In some modes, the positions P1, P2 and P3 are positions where base points, such as feature points, can easily be extracted. To be more specific, the positions P1, P2 and P3 are positions including specific patterns or objects, which can easily be distinguished from other areas. For example, each of the positions P1, P2 and P3 may include a character or sign which is drawn, or may include a boundary between a certain member and another member.

Hereinafter, each of the positions P1 and P3 is also referred to as “base position”. The base position corresponds to one example of the first position in the first example embodiment. In addition, hereinafter, the position P2 is also referred to as “measurement position”. The measurement position corresponds to an example of the second position in the first example embodiment. Each of the base position and measurement position is an area with a certain size, and may include a plurality of feature points that are to be described later.

In the example of FIG. 6, the displacement measurement system 400 images the bridge 600 at a timing when the vehicle is running, and at a timing when the vehicle does not run, and measures a displacement of the floor system. In other words, the displacement measurement system 400 measures a displacement of the floor system at a timing when a load is applied to the bridge 600 and at a timing when no load is applied to the bridge 600.

When displacement measurement is performed, the displacement measurement device 420 acquires in advance intrinsic parameters of the cameras 411a, 411b and 411c. The intrinsic parameters are, for example, an optical axis center and a focal distance. The intrinsic parameters may be provided from a camera maker, or may be obtained in advance by calibration for calculating the intrinsic parameters. In addition, the displacement measurement device 420 acquires in advance parameters indicative of the relative positions and angles of the cameras 411a, 411b and 411c. The parameters correspond to one example of the configuration information in the first example embodiment.

Besides, in the present example embodiment, the calculation unit 422 calculates in advance a homogeneous transformation matrix, before executing displacement measurement. Note that the calculation unit 422 may calculate the homogeneous transformation matrix while executing displacement measurement (e.g. between step S810 and step S820 to be described later). The calculation unit 422 can calculate the homogeneous transformation matrix, for example, by executing the calibration to be illustrated below.

FIG. 7 is an explanatory view illustrating an execution method of calibration for calculating a homogeneous transformation matrix. In this example, patterns 710, 720 and 730 are a plurality of signs, the relative positional relationship of which is already known. The patterns 710, 720 and 730 are provided so as to be immovable at the time of execution of calibration, for example, by being attached to a wall surface. The patterns 710, 720 and 730 are images including specific patterns, and are, for example, chessboard patterns (also called “checkerboard pattern”).

The pattern 710 is imaged by the camera 411a. The pattern 720 is imaged by the camera 411b. The pattern 730 is imaged by the camera 411c. The patterns 710, 720 and 730 are provided at positions where the positioned cameras 411a, 411b and 411c can simultaneously image the patterns 710, 720 and 730.

The calculation unit 422 sets any one of the cameras 411a, 411b and 411c as a base, and calculates a homogeneous transformation matrix indicative of the relationship between the camera of the base and the other cameras. Here, the camera 411a is set as the base. In this case, the calculation unit 422 calculates a homogeneous transformation matrix of four rows and four columns (hereinafter referred to as “M₁₂”) which indicates the relationship between the camera 411a and camera 411b three-dimensionally, and a homogeneous transformation matrix of four rows and four columns (hereinafter referred to as “M₁₃”) which indicates the relationship between the camera 411a and camera 411c three-dimensionally. The calculation unit 422 can calculate the homogeneous transformation matrices M₁₂ and M₁₃ by using any one of general and well-known methods for calculating homogeneous transformation matrices.

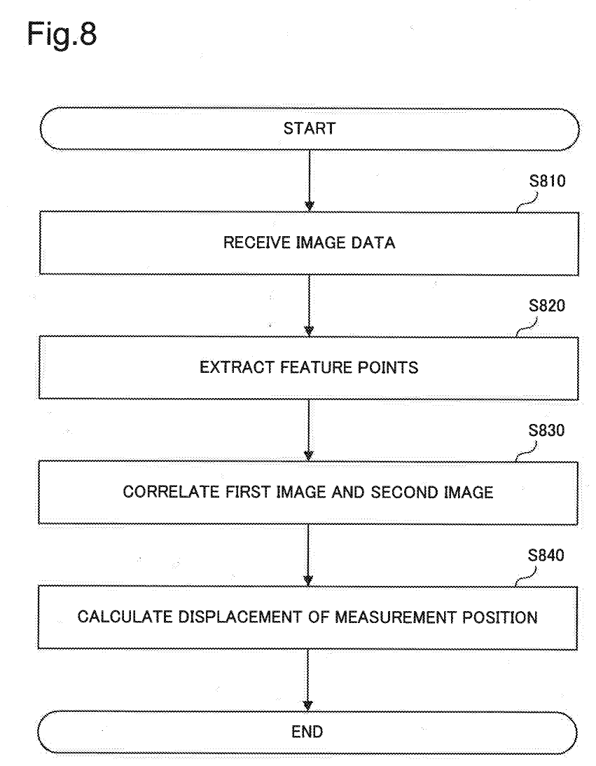

FIG. 8 is a flowchart illustrating a displacement measurement process which the displacement measurement device 420 executes. In step S810, the communication unit 421 receives from the UAV 410 first image data corresponding to the first image and second image data corresponding to the second image. These image data represent images acquired by imaging, from a plurality of different imaging directions, the positions P1, P2 and P3 in a time period in which a specific load is not applied to the bridge 600 and in a time period in which the load is applied to the bridge 600. The UAV 410 executes imaging, for example, in a time period in which the vehicle is running on the bridge 600, and in a period in which the vehicle does not run on the bridge 600. These periods correspond to the “first time period” and “second time period” in the first example embodiment.

For example, the UAV 410 ascends or descends, while flying, so that the positions P1, P2 and P3 may not be located outside the imaging ranges, thereby imaging the positions P1, P2 and P3 at a plurality of imaging positions. In other words, it can be said that the UAV 410 images the positions P1, P2 and P3 from a plurality of viewpoints. For example, the UAV 410 images the positions P1, P2 and P3 such that distortion occurs between the captured images due to ascending or descending.

In step S810, the communication unit 421 acquires image data of a number corresponding to the product between the number of cameras and the number of times of imaging. For example, in the case of the present example embodiment, the number of cameras included in the UAV 410 is “3”. Accordingly, the total number of first images and second images acquired in step S810 is “3M” if the number of times of imaging is “M”.

In step S820, the calculation unit 422 extracts feature points from each of the first images and second images which the plural image data received in step S810 represent. To be more specific, the calculation unit 422 extracts feature points from the position P1, P2 or P3 included in the respective images. Usable feature amounts in step S820 are, for example, feature amounts representing local features of images, such as Features from Accelerated Segment Test (FAST) feature amounts, or Scale-Invariant Feature Transform (SIFT) feature amounts.

In step S830, the calculation unit 422 correlates the first image including the base position and the second image including the measurement position, by using the feature points extracted in step S820. In the present example embodiment, the calculation unit 422 can correlate the first image and second image three-dimensionally, by reconstructing the three-dimensional shape of the feature points by using an algorithm in which bundle adjustment is expanded.

The bundle adjustment is a method of reconstructing (estimating) the three-dimensional shape of a captured scene, based on the base points included in a plurality of images captured by photographing the same position. The bundle adjustment is one of elemental techniques of Structure from Motion (SfM). In the bundle adjustment, captured video is modeled by perspective projection of the following equation (1).

$$\begin{matrix}[ Math . 1 ] & \\ ( \begin{matrix}x \\ y \\ {f}_{0}\end{matrix} ) = sP ( \begin{matrix}X \\ Y \\ Z \\ 1\end{matrix} ) & ( 1 )\end{matrix}$$

In equation (1), x and y are the position of a certain point in an image, i.e. two-dimensional coordinates. In addition, X, Y and Z indicate three-dimensional coordinates of this point in the space. Symbols s and f₀ are freely chosen proportionality factors, which are not zero. P is a matrix of three rows and four columns, which is called “projection matrix”.

The projection matrix P is expressed by the following equation (2), when the focal distance f, the optical axis center is (u₀, v₀), the central position of the lens in a world coordinate system is t=(xₜ, yₜ, zₜ), the rotation matrix representing directions is R, and the identity matrix is I. In equation (2), K is an intrinsic matrix (also called “intrinsic parameter matrix”) relating to the camera. (I-t) is a matrix in which the identity matrix I and t are arranged in the column direction, and is a matrix of three rows and four columns in equation (2).

$$\begin{matrix}[ Math . 2 ] & \\ P = {KR}^{T} ( I - t ) = {KR}^{T} ( \begin{matrix}1 & 0 & 0 & {x}_{t} \\ 0 & 1 & 0 & {y}_{t} \\ 0 & 0 & 1 & {z}_{t}\end{matrix} ) , \\ K = ( \begin{matrix}f / {f}_{0} & 0 & {u}_{0} / {f}_{0} \\ 0 & f / {f}_{0} & {v}_{0} / {f}_{0} \\ 0 & 0 & 1\end{matrix} ) & ( 2 )\end{matrix}$$

When an element of an i-th row and a j-th column of the projection matrix P is expressed as p^{ij}, x and y are expressed by the following equation (3).

$$\begin{matrix}[ Math . 3 ] & \\ x = {f}_{0} \frac{{p}^{11} X + {p}^{12} Y + {p}^{13} Z + {p}^{14}}{{p}^{31} X + {p}^{32} Y + {p}^{33} Z + {p}^{34}} \\ y = {f}_{0} \frac{{p}^{21} X + {p}^{22} Y + {p}^{23} Z + {p}^{24}}{{p}^{31} X + {p}^{32} Y + {p}^{33} Z + {p}^{34}} & ( 3 )\end{matrix}$$

Here, when an N number of points (X_{α}, Y_{α}, Z_{α}) in the scene were photographed M times from mutually different positions, it is assumed that these were observed at a position (x_{α}, y_{α}) of a κ-th image (κ=1, 2, . . . , M, α=1, 2, . . . , N). When the projection matrix for the κ-th image is P_{κ}, the total of sums of squares of displacements between the positions at which all points are to be projected and the observed positions is expressed by the following equation (4). E expressed by equation (4) is called “reprojection error”.

$$\begin{matrix}[ Math . 4 ] & \\ E = {\sum }_{α = 1}^{N} {\sum }_{κ = 1}^{M} {I}_{α κ} [ {( \frac{{p}_{α κ}}{{r}_{α κ}} - \frac{{x}_{α κ}}{{f}_{0}} )}^{2} + {( \frac{{q}_{α κ}}{{r}_{α κ}} - \frac{{y}_{α κ}}{{f}_{0}} )}^{2} ] & ( 4 )\end{matrix}$$

Here, I_{ακ} is a visualization index. The visualization index I_{ακ} is “1” when the point (X_{α}, Y_{α}, Z_{α}) appears in the κ-th image, and is “0” when the point (X_{α}, Y_{α}, Z_{α}) does not appear in the κ-th image. In addition, an error on the image, if measured by the distance with the proportionality factor f₀^{ij} being “1”, is expressed by the following equation (5). Here, P_{κ}^{ij} represents an element of an i-th row and a j-t column of the projection matrix P_{κ}.

$$\begin{matrix}[ Math . 5 ] & \\ {p}_{α κ} = {P}_{κ}^{11} {X}_{α} + {P}_{κ}^{12} {Y}_{α} + {P}_{κ}^{13} {Z}_{α} + {P}_{κ}^{14} \\ {q}_{α κ} = {P}_{κ}^{11} {X}_{α} + {P}_{κ}^{22} {Y}_{α} + {P}_{κ}^{23} {Z}_{α} + {P}_{κ}^{24} \\ {r}_{α κ} = {P}_{κ}^{31} {X}_{α} + {P}_{κ}^{32} {Y}_{α} + {P}_{κ}^{33} {Z}_{α} + {P}_{κ}^{34} & ( 5 )\end{matrix}$$

In general SfM, to estimate the point (X_{α}, Y_{α}, Z_{α}) and projection matrix P_{κ}, which minimize the reprojection error of equation (4) for one camera, is the method of reconstructing the three-dimensional shape of the scene. By contrast, in the present example embodiment, a plurality of cameras are used. In consideration of the use of plural cameras, the SfM of the present example embodiment has a feature in that the general SfM is expanded by using a homogeneous transformation matrix M_{1γ} (γ is the number of cameras).

Specifically, the projection matrix P_{γ}(γ=1, . . . , L) of the present example embodiment is expressed by the following equation (6). In other words, the projection matrices P_{γ} (varying from camera to camera) are mutually associated by the homogeneous transformation matrix M_{1γ}. It is assumed, however, that M₁₁ is an identity matrix.

[Math. 6]

P_{γ}R(I−t)M_{1γ} (6)

In addition, the reprojection error E of the present example embodiment is expressed by the following equation (7). In equation (7), p_{αγκ}, g_{αγκ}, and r_{αγκ} are expressed by the following equation (8). Here, P_{γκ}^{ij} represents an element of an i-th row and a j-th column of the projection matrix P_{γκ}. The projection matrix P_{γκ} is calculated for each image and each camera. In addition, I_{αγκ} is a visualization index similar to I_{ακ}.

$$\begin{matrix}[ Math . 7 ] & \\ E = {\sum }_{γ = 1}^{L} {\sum }_{α = 1}^{N} {\sum }_{κ = 1}^{M} {I}_{αγ κ} [ {( \frac{{p}_{αγ κ}}{{r}_{αγ κ}} - \frac{{x}_{α γκ}}{{f}_{0}} )}^{2} + {( \frac{{q}_{αγ κ}}{{r}_{αγ κ}} - \frac{{y}_{α γκ}}{{f}_{0}} )}^{2} ] & ( 7 ) \\ [ Math . 8 ] & \\ {p}_{αγ κ} = {P}_{γκ}^{11} {X}_{α} + {P}_{γκ}^{12} {Y}_{α} + {P}_{γκ}^{13} {Z}_{α} + {P}_{γκ}^{14} \\ {q}_{αγ κ} = {P}_{γκ}^{11} {X}_{α} + {P}_{γκ}^{22} {Y}_{α} + {P}_{γκ}^{23} {Z}_{α} + {P}_{γκ}^{24} \\ {r}_{αγ κ} = {P}_{γκ}^{31} {X}_{α} + {P}_{γκ}^{32} {Y}_{α} + {P}_{γκ}^{33} {Z}_{α} + {P}_{γκ}^{34} & ( 8 )\end{matrix}$$

In the present example embodiment, the calculation unit 422 calculates the point (X_{α}, Y_{α}, Z_{α}) and projection matrix P_{γκ}, which minimize the reprojection error of equation (7) for the observed (x_{αγκ}, y_{αγκ}). Equation (7) makes it possible to evaluate images captured by plural cameras by one reprojection error equation. Note that the calculation unit 422 can calculate the point (X_{α}, Y_{α}, Z_{α}) and projection matrix P_{γκ}, by applying the well-known method described in NPL 2.

The process of step S830 is as described above. In this manner, if the feature points included in the first images or the second images are correlated, the calculation unit 422 calculates a displacement of the measurement position in step S840. At this time, the calculation unit 422 searches for the correspondence relation of the feature points extracted in the first time period (the state with no load) and the second time period (the state with a load) by a well-known robust estimation method such as Random Sample Consensus (RANSAC).

The feature points extracted in step S820 may include not only correct correspondence (inlier) but also erroneous correspondence (outlier). A feature point that is judged as an outlier is excluded from the feature points constituting the captured scene in step S840. Hereinafter, the feature point judged as an inlier, i.e. judged as having a correct correspondence relation, is also referred to as “corresponding point”.

The calculation unit 422 executes alignment between the feature points, which were extracted in the first time period and from which the three-dimensional shape was estimated, and the feature points, which were extracted in the second time period and from which the three-dimensional shape was estimated. A well-known method such as Iterative Closest Point (ICP) algorithm is applicable to the alignment between these point groups. The calculation unit 422 iteratively calculates the combination of feature points, which minimizes the error after the alignment.

In the alignment, the calculation unit 422 assumes that there is no displacement between the corresponding points extracted from the first images in the first time period and second time period. In other words, the calculation unit 422 sets a presupposition that an error between the corresponding points extracted from the first images in the first time period and second time period is sufficiently smaller (i.e. negligibly smaller) than an error between the corresponding points extracted from the second images in these time periods. By assuming this, a displacement of the measurement position can be expressed as an error (i.e. residual) remaining after the alignment.

As described above, the displacement measurement system 400 is configured to evaluate images captured by plural cameras (411a, 411b, 411c) by one reprojection error equation. This configuration can avoid restrictions in the general SfM in which the number of cameras used when the three-dimensional shape is reconstructed from images is one. If a plurality of cameras can be used in the displacement measurement, it is possible to locally image only the position that is to be measured on the measurement object. Thus, according to the displacement measurement system 400, even when the measurement object is a large object such as the bridge 600, the resolution per unit area of the image including the measurement object can be enhanced, and therefore the displacement of the measurement object can be measured with high precision.

### Third Example Embodiment

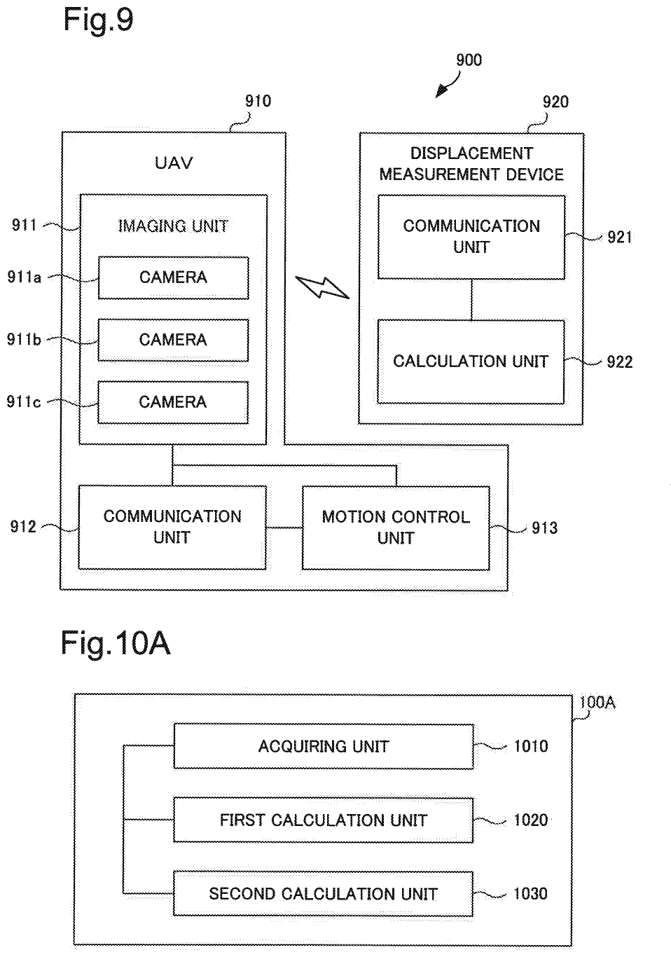

FIG. 9 is a block diagram illustrating a configuration of a displacement measurement system 900 according to still another example embodiment. The displacement measurement system 900 has a similar configuration to the displacement measurement system 400 (see FIG. 4) of the second example embodiment, except for a configuration of a UAV 910. In the present example embodiment, a description of the similar configuration to the second example embodiment is omitted unless otherwise necessary.

The UAV 910 includes a motion control unit 913 in addition to an imaging unit 911 and a communication unit 912. Cameras 911a, 911b and 911c are different from the cameras 411a, 411b and 411c of the second example embodiment, in that the cameras 911a, 911b and 911c are configured such that their positional relationship is variable.

The motion control unit 913 controls the movement of the cameras 911a, 911b and 911c. The motion control unit 913 can control the positions or imaging directions of the cameras 911a, 911b and 911c. By the control of the motion control unit 913, the cameras 911a, 911b and 911c change their relative positions or angles. The motion control unit 913 controls the movement of the cameras 911a, 911b and 911c, for example, by driving servo motors or linear-motion-type actuators.

The control by the motion control unit 913 may be remote control, i.e. control by the displacement measurement device 420 or other remote-control equipment. Alternatively, the control by the motion control unit 913 may be control based on images captured by the cameras 911a, 911b and 911c. For example, the motion control unit 913 may control the positions or imaging directions of the cameras 911a, 911b and 911c so as to continue photographing a specific position of the measurement object.

The motion control unit 913 supplies configuration information to the communication unit 912. The configuration information of the present example embodiment includes information indicative of imaging conditions (relative positions, angles, etc.) of the cameras 911a, 911b and 911c. For example, the configuration information includes information indicative of displacements or rotational angles of the cameras 911a, 911b and 911c from a position that is a base position. The motion control unit 913 does not need to always supply the configuration information to the communication unit 912, and may supply the configuration information to the communication unit 912 only when a change occurs in the configuration information.

Note that the cameras 911a, 911b and 911c may have optical zoom functions. Specifically, the cameras 911a, 911b and 911c may have mechanisms for capturing images by optically enlarging (or reducing) the images. In this case, the imaging magnification by each of the cameras 911a, 911b and 911c can be set independently (i.e. regardless of the imaging magnifications of other cameras). In this case, the configuration information may include information indicative of the imaging magnifications of the cameras 911a, 911b and 911c.

The communication unit 912 transmits to a displacement measurement device 920 the configuration information supplied from the motion control unit 913, in addition to the image data. The configuration information, for example, may be embedded in the image data as metadata of the image data. The configuration information may be information indicative of a difference from an immediately previous state of each of the cameras 911a, 911b and 911c.

The displacement measurement device 920 includes a communication unit 921 and a calculation unit 922. The communication unit 921 differs from the communication unit 421 of the second example embodiment in that the communication unit 921 receives the configuration information as well as the image data. The calculation unit 922 differs from the calculation unit 422 of the second example embodiment in that the calculation unit 922 calculates (i.e. changes) the homogeneous transformation matrix, based on the configuration information received from the communication unit 921.

The calculation unit 922 may execute the calibration as illustrated in FIG. 7 multiple times in advance, with respect to all assumable combinations of the positional relationship between the cameras 911a, 911b and 911c, and may calculate in advance the homogeneous transformation matrix for each combination. Alternatively, the calculation unit 922 may estimate a homogeneous transformation matrix after a change, based on a variation from the immediately previous state of the configuration information. The calculation unit 922 can calculate the homogeneous transformation matrix, for example, based on forward kinematics and inverse kinematics of manipulators in robotics.

Note that the displacement measurement process, which the calculation unit 922 executes, is similar to the displacement measurement process (see FIG. 8) of the second example embodiment, except that the homogeneous transformation matrix M_{1γ} of equation (6) can be changed in accordance with the change of the configuration information. Specifically, the homogeneous transformation matrix of the present example embodiment can be changed in accordance with the change of the movement of the cameras 911a, 911b and 911c by the motion control unit 913.

As described above, the displacement measurement system 900 is configured to control the movement of the cameras 911a, 911b and 911c and to calculate a displacement of the measurement object by using the homogeneous transformation matrix corresponding to the movement of the cameras 911a, 911b and 911c. The similar advantageous effects to those of the displacement measurement system 400 of the second example embodiment can be obtained by the displacement measurement system 900. In addition, the displacement measurement system 900 can calculate the displacement of the measurement object, even without the configuration in which the cameras 911a, 911b and 911c are fixed immovably.

[Modifications]

The present disclosure is not limited to the above-described first example embodiment to third example embodiment. For example, the present disclosure includes modifications which are described below. In addition, the present disclosure may include modes in which the matters described in the present description specification are properly combined or replaced as needed. For example, the matters described by using a specific example embodiment can be applied to the other example embodiments within the range in which no contradiction occurs. Moreover, the present disclosure may include, in addition to these example embodiments, other example embodiments to which modifications or applications that are understandable by a so-called person skilled in the art are applied.

(Modification 1)

The UAV 410 may include a configuration for measuring an angular velocity or acceleration. For example, the UAV 410 may be configured to include a so-called Inertial Measurement Unit (IMU). The angular velocity and acceleration measured by the IMU make it possible to calculate the variations of the angle and position of the UAV 410 by integration.

The calculation of equation (7) is an optimization calculation with a relatively large number of unknown numbers, in which the point (X_{α}, Y_{α}, Z_{α}) in the scene, and the central position t of the lens and the rotation matrix R included in the projection matrix P_{γκ} are calculated. However, if the IMU is used, since the central position t of the lens and the rotation matrix R can be calculated from the change of the angle and position of the UAV 410, these can be treated as known values.

(Modification 2)

In general, in the three-dimensional position of the scene, i.e. the point (X_{α}, Y_{α}, Z_{α}), which is calculated by the SfM, there exists indefiniteness of the scale in relation to the three-dimensional position in the real world. The indefiniteness in this context refers to such a property that the proportionality factor s in equation (1) cannot uniquely be specified from the reprojection error E of equation (4) or equation (7). Because of the indefiniteness, the displacement calculated by the calculation unit 422 cannot be described by the unit which represents an absolute length, such as meters, and is expressed by a relative ratio to a position serving as a base.

The calculation unit 422 may calculate the ratio between the amount of movement of the camera, which is calculated by the SfM, and the actual amount of movement, in order to express the displacement by the unit representing the absolute length. The actual amount of movement of the camera can be calculated, for example, by using an inertia sensor or an atmospheric pressure sensor.

The calculation unit 422 records the position of a specific camera (here, the camera 411a, for instance) among the plural cameras. Hereinafter, the position of the camera 411a at the time of capturing the κ-th image is defined as “t_{κ}”. In addition, the central position t_{κ}, of the lens, which is calculated by minimizing the reprojection error E of equation (7), corresponds to the position of the camera 411a at the time of capturing the κ-th image. Accordingly, the following equation (9) is established between the position t_{κ}, the central position t_{κ} and the proportionality factor s.

[Math. 9]

t′_{κ}=st_{κ} (9)

The calculation unit 422 can calculate a displacement of, e.g. the meter unit, by calculating the proportionality factor s from equation (9). Specifically, the calculation unit 422 can describe the displacement by the unit representing the absolute length, by multiplying the displacement, which is calculated by minimizing the reprojection error E of equation (7), by the proportionality factor s.

(Modification 3)

The displacement measurement device 420 may set a point (hereinafter referred to as “steady point”), which is a base point, from among a plurality of corresponding points. The steady point is selected from among the corresponding points included in the first image, i.e. the image including the base position. The displacement measurement device 420 may calculate the position of the camera, which is based on the steady point, and may measure the position of a corresponding point (hereinafter “movable point”) which is not the steady point, based on the calculated position of the camera. The movable point is selected from among the corresponding points included in the second image, i.e. the image including the measurement position.

The displacement measurement device 420 may calculate a displacement of the measurement object, based on the difference between the position of the movable point which is estimated from the position of the steady point, and the position of the movable point which was actually measured. Thereby, the displacement measurement device 420 can calculate the displacement of the movable point in real time.

Specifically, the process, which is executed in the displacement measurement device 420, is as follows. To begin with, the calculation unit 422 acquires the positions (X_{α}, Y_{α}, Z_{α}) of the corresponding points in advance, based on the images captured in the first time period, and specifies their positional relationship (where α=1, 2, . . . , N). Next, the calculation unit 422 sets a steady point (X_{f}, Y_{f}, Z_{f}) and a movable point (Xₘ, Yₘ, Zₘ) from among these corresponding points. Here, f and m are a set of nonoverlapping values among the values which α can take. Specifically, the sum of steady points and movable points is equal to the total number of steady points.

When the displacement of the steady point is calculated in real time, the calculation unit 422 minimizes reprojection errors E_{F} and E_{M} of the steady point and movable point by using the following equation (10) and equation (11), and estimates the respective central positions t of the lenses and the rotation matrices R. At this time, since the positions (X_{α}, Y_{α}, Z_{α}) of the corresponding points are already known, these values are treated as fixed values.

$$\begin{matrix}[ Math . 10 ] & \\ {E}_{F} = {\sum }_{γ = 1}^{L} {\sum }_{α ∈ f} {I}_{α γ} [ {( \frac{{p}_{α γ}}{{r}_{α γ}} - \frac{{x}_{α γ}}{{f}_{0}} )}^{2} + {( \frac{{q}_{α γ}}{{r}_{α γ}} - \frac{{y}_{α γ}}{{f}_{0}} )}^{2} ] & ( 10 ) \\ [ Math . 11 ] & \\ {E}_{M} = {\sum }_{γ = 1}^{L} {\sum }_{α ∈ m} {I}_{α γ} [ {( \frac{{p}_{α γ}}{{r}_{α γ}} - \frac{{x}_{α γ}}{{f}_{0}} )}^{2} + {( \frac{{q}_{α γ}}{{r}_{α γ}} - \frac{{y}_{α γ}}{{f}_{0}} )}^{2} ] & ( 11 )\end{matrix}$$

If the reprojection errors of equation (10) and equation (11) are minimized, the central position and rotation matrix based on the steady point and the central position and rotation matrix based on the movable point can be calculated. Hereinafter, the central position and rotation matrix based on the steady point are expressed as “t_{F}” and “R_{F}”, respectively. In addition, the central position and rotation matrix based on the movable point are expressed as “t_{M}” and “R_{M}”, respectively.

These central positions and rotation matrices can be expressed as indicated by the following equation (12), if differences due to the displacement of the movable point are Δt and ΔR. These matrices are expressed as homogeneous transformation matrices by adding a fourth row to the matrices of three rows and four columns (see equation (2)) representing the central positions of lenses and the rotations, so that inverse matrixes can be calculated.

$$\begin{matrix}[ Math . 12 ] & \\ ( \begin{matrix}{R}_{F} ( I - {t}_{F} ) \\ 0 \; 0 \; 0 \; 1\end{matrix} ) = ( \begin{matrix}{R}_{M} ( I - {t}_{M} ) \\ 0 \; 0 \; 0 \; 1\end{matrix} ) ( \begin{matrix}Δ R ( I - Δ t ) \\ 0 \; 0 \; 0 \; 1\end{matrix} ) & ( 12 )\end{matrix}$$

With respect to equation (12), if an inverse matrix of a homogeneous transformation matrix, which is based on the central position and rotation matrix based on the movable point, is multiplied from the left, a homogeneous transformation matrix of the difference of the central position and rotation matrix can be calculated as indicated by the following equation (13).

$$\begin{matrix}[ Math . 13 ] & \\ ( \begin{matrix}Δ R ( I - Δ t ) \\ 0 \; 0 \; 0 \; 1\end{matrix} ) = {( \begin{matrix}{R}_{M} ( I - {t}_{M} ) \\ 0 \; 0 \; 0 \; 1\end{matrix} )}^{- 1} ( \begin{matrix}{R}_{F} ( I - {t}_{F} ) \\ 0 \; 0 \; 0 \; 1\end{matrix} ) & ( 13 )\end{matrix}$$

In equation (13), At and AR represent a displacement of the movable point, which is based on the steady point. Specifically, by acquiring in advance the positions (X_{α}, Y_{α}, Z_{α}) of the corresponding points and operating as described above, the calculation unit 422 can calculate the displacement of the movable point without executing the imaging multiple times in the second time period. Therefore, the calculation unit 422 can calculate the displacement of the measurement object by imaging the measurement object only once, without changing the imaging position.

(Modification 4)

The base point according to the present disclosure is not limited to the feature point based on the feature amount. For example, as the method of reconstructing the three-dimensional shape, there is also known a method using not the feature amount but the luminance or color of pixels. The displacement measurement method according to the present disclosure is also applicable to such methods. The displacement measurement method according to the present disclosure is also applicable to, for example, position estimation using Parallel Tracking and Mapping for Small AR Workspaces (PTAM), Large-Scale Direct Monocular Simultaneous Localization and Mapping (LSD-SLAM), or the like. The base point according to the present disclosure may be a specific pixel used in such methods.

(Modification 5)

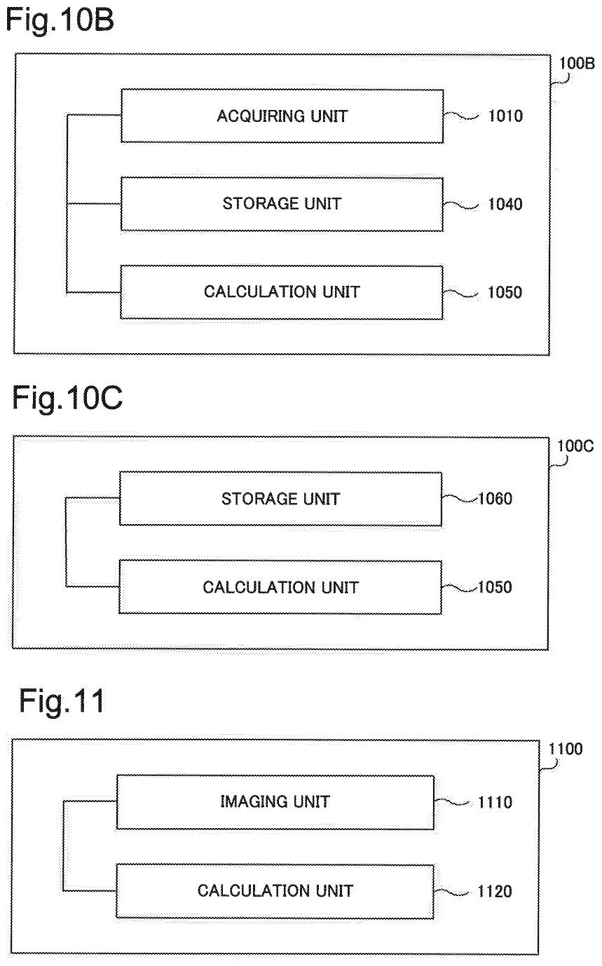

FIG. 10A, FIG. 10B and FIG. 10C are block diagrams illustrating modifications of the displacement measurement device 100 according to the first example embodiment. A displacement measurement device 100A illustrated in FIG. 10A includes an acquiring unit 1010, a first calculation unit 1020 and a second calculation unit 1030. A displacement measurement device 100B illustrated in FIG. 10B includes the acquiring unit 1010, a storage unit 1040, and a calculation unit 1050. A displacement measurement device 100C illustrated in FIG. 10C includes a storage unit 1060 and the calculation unit 1050. Note that the acquiring unit 1010 has a similar configuration and function to those of the acquiring unit 110 of the first example embodiment. In addition, the calculation unit 1050 has a similar configuration and function to those of the calculation unit 120 of the first example embodiment.

In the displacement measurement device 100A, the first calculation unit 1020 calculates the correlation information. Concrete calculation methods of the correlation information may be similar to those in the first example embodiment to third example embodiment. The second calculation unit 1030 calculates a displacement of the second position (measurement position) by using the first images and second images acquired by the acquiring unit 1010 and the correlation information calculated by the first calculation unit 1020. Concrete calculation methods of the second position may be similar to those in the first example embodiment to third example embodiment.

In the displacement measurement device 100B, the storage unit 1040 stores the correlation information. The storage unit 1040 stores the correlation information which was calculated by some other device in advance (i.e. before imaging the measurement object). Accordingly, the displacement measurement device 100B does not need to calculate the correlation information.

In the displacement measurement device 100C, the storage unit 1060 stores all images necessary for displacement measurement, and the correlation information. The storage unit 1060 stores the correlation information which was calculated by some other device in advance. In addition, the storage unit 1060 stores images which were captured in advance. Like the displacement measurement device 100B, the displacement measurement device 100C does not need to calculate the correlation information.

(Modification 6)

The displacement measurement system according to the present disclosure is not limited to the configuration of the second example embodiment or third example embodiment. For example, the displacement measurement system according to the present disclosure may not necessarily include the UAV.

FIG. 11 is a block diagram illustrating another example of the displacement measurement system according to the present disclosure. A displacement measurement system 1100 is configured to include an imaging unit 1110 and a calculation unit 1120. In the displacement measurement system 1100, the imaging unit 1110 and calculation unit 1120 may be included in a single device. Alternatively, like the displacement measurement system 400, the displacement measurement system 1100 may be constituted by a first device (e.g. a digital camera) which is movable and includes the imaging unit 1110, and a second device (e.g. a personal computer) which includes the calculation unit 1120. The first device and second device may be connected not by radio, but by wire.

The imaging unit 1110 captures a first image including a first position and a second image including a second position in a first time period and in a second time period. The calculation unit 1120 calculates a displacement of the second position, the displacement being based on the first position, using the first image and second image and the correlation information calculated based on the configuration information of the imaging unit 1110.

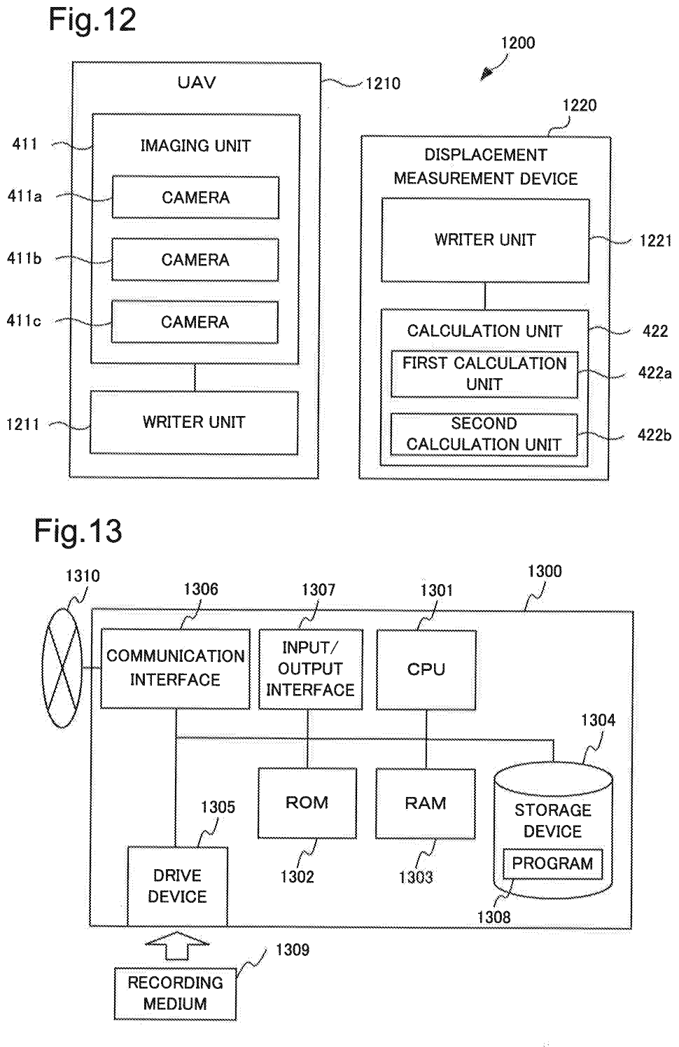

FIG. 12 is a block diagram illustrating still another example of the displacement measurement system according to the present disclosure. A displacement measurement system 1200 includes a UAV 1210 and a displacement measurement device 1220. The UAV 1210 differs from the UAV 410 of the second example embodiment in that the UAV 1210 includes a writer unit 1211 in place of the communication unit 412. The displacement measurement device 1220 differs from the displacement measurement device 420 of the second example embodiment in that the displacement measurement device 1220 includes a reader unit 1221 in place of the communication unit 421. Except for these points, the UAV 1210 and displacement measurement device 1220 have configurations common to the UAV 410 and displacement measurement device 420 of the second example embodiment.

The writer unit 1211 stores in a detachable recording medium the image data supplied from the imaging unit 411. The recording medium is, for example, a so-called Universal Serial Bus (USB) memory or a memory card. The reader unit 1221 reads the image data from the recording medium in which the image data was stored by the writer unit 1211. Each of the writer unit 1211 and reader unit 1221 is, for example, a reader/writer of memory cards.

The UAV 1210 and displacement measurement device 1220 do not need to transmit/receive image data. When imaging by the UAV 1210 is finished, the user takes out the recording medium, in which image data are stored, from the UAV 1210, and attaches the recording medium to the displacement measurement device 1220. The displacement measurement device 1220 reads the image data from the recording medium which was attached by the user, and calculates the displacement.

(Modification 7)

A concrete hardware configuration of the displacement measurement device according to the present disclosure includes many variations and is not limited to a specific configuration. For example, the displacement measurement device according to the present disclosure may be realized by using software, or may be configured to share various processes by using a plurality of pieces of hardware.

FIG. 13 is a block diagram illustrating an example of a hardware configuration of a computer device 1300 which realizes the displacement measurement device according to the present disclosure. The computer device 1300 is configured to include a Central Processing Unit (CPU) 1301, a Read-Only Memory (ROM) 1302, a Random Access Memory (RAM) 1303, a storage device 1304, a drive device 1305, a communication interface 1306, and an input/output interface 1307. The displacement measurement device according to the present disclosure is realized by the configuration (or a part of the configuration) illustrated in FIG. 13.

The CPU 1301 executes a program 1308 by using the RAM 1303. The program 1308 may be stored in the ROM 1302. Alternatively, the program 1308 may be stored in a recording medium 1309 such as a memory card and may be read by the drive device 1305, or the program 1308 may be transmitted from an external device via a network 1310. The communication interface 1306 exchanges data with the external device via the network 1310. The input/output interface 1307 exchanges data with peripheral equipment (an input device, a display device, etc.). The communication interface 1306 and input/output interface 1307 can function as constituent elements for acquiring or outputting data.

Note that the constituent elements of the displacement measurement device according to the present disclosure may be composed of single circuitry (a processor or the like), or may be composed of a combination of a plurality of circuitries. The circuitry in this context may be general-purpose circuitry or purpose-specific circuitry. For example, a part of the displacement measurement device according to the present disclosure may be realized by a purpose-specific processor, and the other part may be realized by a general-purpose processor.

The configuration described as a single device in the above example embodiments may be provided in a plurality of devices in a distributed fashion. For example, the displacement measurement device 100, 420 or 920 may be realized by cooperation of a plurality of computer devices, by using cloud computing technology or the like.

The present application claims priority based on Japanese Patent Application No. 2016-184451, filed Sep. 21, 2016; the entire contents of which are incorporated herein by reference.

### REFERENCE SIGNS LIST

100, 420, 920, 100A, 100B, 100C, 1220 Displacement measurement device
110, 1010 Acquiring unit
120, 422, 922, 1050, 1120 Calculation unit
400, 900, 1100, 1200 Displacement measurement system
410, 910, 1210 UAV
411, 911, 1110 Imaging unit
411a, 411b, 411c, 911a, 911b, 911c Camera
913 Motion control unit
422a, 1020 First calculation unit
422b, 1030 Second calculation unit
1300 Computer device

1. A displacement measurement device comprising:
acquiring unit acquiring an image comprising a first position and an image comprising a second position, which are captured by imaging unit in a first time period, and an image comprising the first position and an image comprising the second position, which are captured by the imaging unit in a second time period; and
calculation unit for calculating a difference between the second position in the first time period and the second position in the second time period, the difference being based on the first position, using a plurality of the acquired images and correlation information calculated based on configuration information of the imaging unit.

2. The displacement measurement device according to claim 1, wherein the imaging unit comprises a plurality of cameras, and
the configuration information comprises information indicative of imaging conditions of the plural cameras.

3. The displacement measurement device according to claim 2, wherein the configuration information comprises information indicative of relative positions or angles of the plural cameras.

4. The displacement measurement device according to claim 3, wherein the configuration information changes in accordance with a change of the relative positions or angles of the plural cameras.

5. The displacement measurement device according to claim 1, wherein the acquiring unit acquires images comprising the first position and images comprising the second position, which are captured from a plurality of imaging directions in the first time period, and
the calculation unit three-dimensionally correlates base points included in the first position and base points included in the second position by using the correlation information, and calculates a three-dimensional displacement of the second position.

6. The displacement measurement device according to claim 5, wherein the base points comprise feature points extracted based on local features of the images.

7. The displacement measurement device according to claim 1, further comprising storage unit storing the correlation information.

8. The displacement measurement device according to claim 1, wherein the calculation unit comprises:
first calculation unit calculating the correlation information, based on the configuration information; and
second calculation unit calculating a difference between the second position in the first time period and the second position in the second time period, the difference being based on the first position, using a plurality of the acquired images and the calculated correlation information.

9. A displacement measurement system comprising:
imaging unit capturing an image comprising a first position and an image comprising a second position in a first time period and in a second time period; and
calculation unit calculating a difference between the second position in the first time period and the second position in the second time period, the difference being based on the first position, using a plurality of the acquired images and correlation information calculated based on configuration information of the imaging unit.

10. A displacement measurement method comprising:
acquiring an image comprising a first position and an image comprising a second position, which are captured by imaging means in a first time period, and an image comprising the first position and an image comprising the second position, which are captured by the imaging unit in a second time period; and
calculating a difference between the second position in the first time period and the second position in the second time period, the difference being based on the first position, using a plurality of the acquired images and correlation information calculated based on configuration information of the imaging unit.

11. (canceled)
